(19) United States
(12) Patent Application Publication
(10) Pub. No.: US 2014/0071573 A1
(43) Pub. Date: Mar. 13, 2014

(54) Electrical Load Controller with Neutral Detection

(71) Applicants: Louia Weidman, Carlsbad, CA (US); Fengyu Shen, Shanghai (CN)

(72) Inventors: Louia Weidman, Carlsbad, CA (US); Fengyu Shen, Shanghai (CN)

(73) Assignee: The Watt Stopper, Inc.

(21) Appl. No.: 13/609,088

(22) Filed: Sep. 10, 2012

(51) Int. Cl. H02H 9/08

(52) U.S. Cl. 361/93.9

(57) ABSTRACT

An electrical load control device as disclosed above is capable of detecting when it has been connected to either a leakage type (two-wire) or a Neutral type (three-wire) power input and automatically adjust its operation accordingly. In leakage operation the leakage current is limited to 0.5 ma and in three-wire or neutral operation the power supply provides more current than in leakage operation. In neutral operation, one or more signals are provided to the microprocessor to enable operation of indicator or other power consuming elements.

### FIELD OF THE INVENTIONS

The inventions described below relate the field of electrical load controls and more specifically, load controllers capable of automatically determining the type or power applied.

### BACKGROUND OF THE INVENTIONS

Many lighting control products use leakage to load or leakage to ground power supply circuits to accommodate installations where there are only two power wires available. Typically, two power wires are available at wall switches that control AC line or hot voltage switched to a load. The load is subsequently connected to the neutral return wire at the load. Typically, the wall box is earth grounded to meet building codes, so a ground connection is also available. A leakage to load power supply typically robs power from the line and load wires in the wall box, and leaks the return current to the load. A leakage to ground power supply typically robs power from the line wire, but leaks return current to the earth ground connection; certain safety standards limit this current to 0.5 milliamperes (RMS) or less, and this limits the amount of power available for the control circuit to perform its functions. Many leakage-type power supplies store energy during periods of low power need for use during periods of high power need, such as when a relay must be controlled or an LED indicator must be activated (requires several milliamperes of current). New installations often have three power wires available (line, load, neutral) so the controller can be connected to the line and neutral wires and have plenty of power available to perform high power needs at any time.

Typical prior art electrical load controllers are designed to be wired either with a leakage-type supply (two wire) or as a normal supply (three wire). However, due to issues with leakage current in the earth ground return in large buildings having many leakage-type controllers, building codes will be changing such that three wire power be available at all times and leakage to ground connections will be banned. While it is possible to transition those products to a leakage to load supply design, those supplies have problems that are well known in the art, such as causing lamps to flash due to leakage current build up in the corresponding ballast. As such, it is better to transition directly to controllers with a three-wire supply design. However, it typically takes many years for building codes to be formally and universally adopted in local cities and equipment suppliers keep both types of controllers available.

### SUMMARY

The devices and methods described below provide for an electrical load control device capable of detecting when it has been connected to either a leakage type (two-wire) or a Neutral type (three-wire) power supply and automatically adjust its operation accordingly. In leakage operation the leakage current is limited to 0.5 ma and in three-wire operation the power supply provides more current than in leakage operation. In neutral operation, one or more signals are provided to the microprocessor to enable operation of indicator or other power consuming elements.

A load control device for controlling the application of electrical power to a load includes a controller having a microprocessor, one or more status indicators and a half-wave power supply. The power supply includes a constant current source and a neutral line detector. The power supply is operable to limit output current to a preset limit when electrical power is supplied using only an earth wire and a hot wire and the power supply is operative to deliver output current higher than the preset limit when electrical power is supplied using a neutral wire, an earth wire and a hot wire. The neutral line detector generates one or more signals indicative of the electrical power being supplied by a neutral wire, an earth wire and a hot wire, the controller using the one or more signals to control the one or more status indicators.

The power supply may be a negative or positive half-wave supply to minimize cost and complexity. A full-wave power supply may also be used. In the detailed description below, the circuits will be described in reference to a negative half-wave supply.

### BRIEF DESCRIPTION OF THE DRAWINGS

FIG. 1 is a perspective view of an electrical system with leakage type and neutral type wiring and a neutral detecting load controller.

FIG. 2 is a block diagram of a neutral detecting load controller.

FIG. 3 is a schematic diagram of the power supply of the neutral detecting load controller of FIG. 2.

### DETAILED DESCRIPTION OF THE INVENTIONS

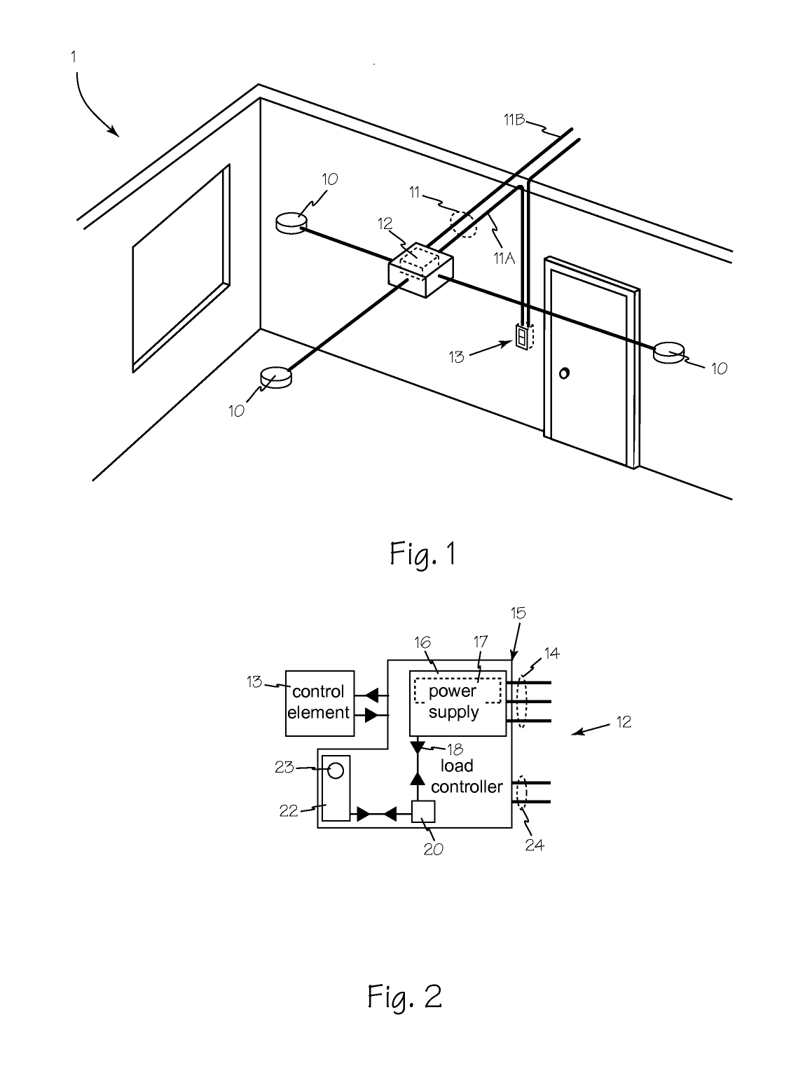

Locations containing electrical loads 10 and electrical power lines 11 such as room 1 of FIG. 1 include one or more load controllers such as electrical load control device 12. Power lines 11 may have only two conductors such as line 11A, or have three conductors such as line 11B.

Load control devices such as load control device 12 may be controlled by any suitable type of load control element 13 such as a switch, dimmer, ballast or LED driver. As shown in FIG. 2, each load control device is connected to one or more control elements such as load control element 13 and includes microcontroller 20. The load control element is the user interface with the load control device and is any suitable device such as a toggle switch, rocker switch, slide switch, touch panel or touch screen. Electrical power is applied on either two or three conductors 14 at input 15. The microcontroller includes power supply 16 which is a half wave power supply that is capable of detecting if the electrical power input is using two or three conductors. If three conductors are used for the input power, they are hot, neutral and earth. The presence of a neutral wire determined by a detector 17 in power supply 16. Neutral detector 17 generates one or more signals 18 which are applied to microprocessor 20. The presence of signals 18 is used by microprocessor 20 in control device 12 to configure the operation of load control device 12. With only two conductors applying power to load control device 12, the device is operating on leakage current and is limited in internal power usage. With three conductors applying power to load control device 12, there is plenty of available power and load control device 12 may utilize one or more indicators 22 such as light 23 or other devices that would exceed the 0.5 ma electrical code safety limit. Power is applied to loads such as loads 10 through output lines 24.

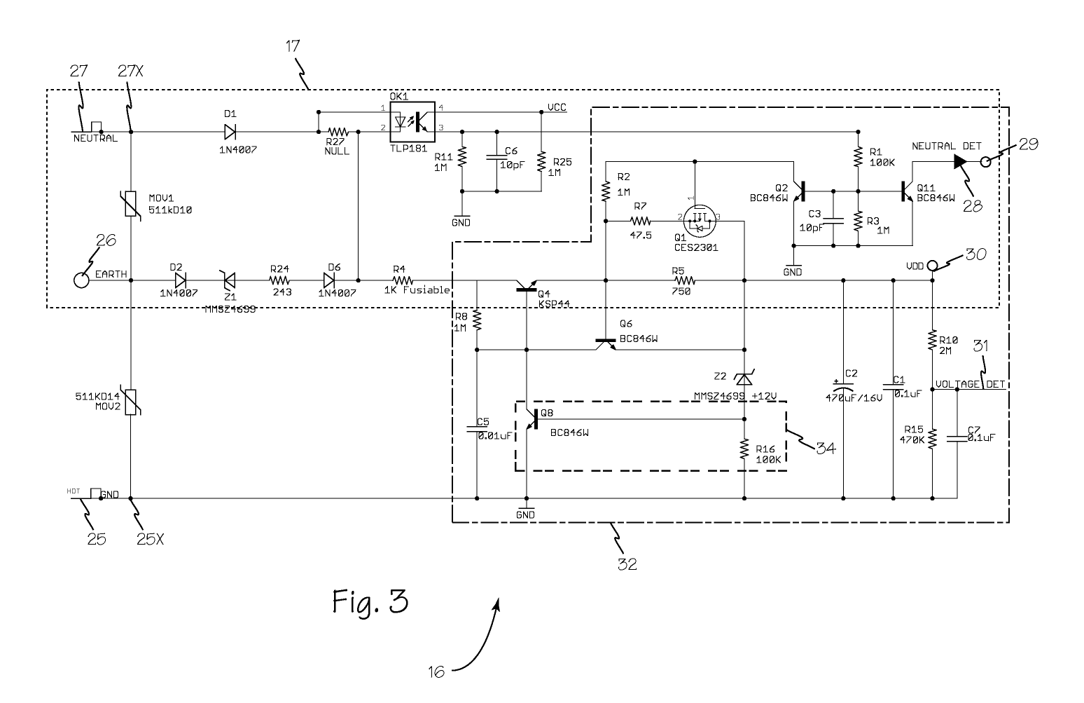

Power supply 16 is a half-wave supply and is illustrated in FIG. 3 and may use the negative half-wave or the positive half-wave or a full-wave signal. In power supply 16, the hot lead/terminal/conductor, conductor 25 connects to the control power supply ground reference at point 25X. If only two conductors are used the other conductor is earth or ground and is connected to earth terminal 26. If a third conductor applies power to load control device 12, the third conductor is neutral conductor 27 and is connected to terminal 27X. Earth ground is not required to detect the presence or absence of a live third input connection.

When earth is connected at terminal 26, current in the negative cycle goes through the following components to generate a power supply voltage: earth terminal 26, D2 (rectifying diode), Z1, R24, D6, R4, Q4, R5, Z2, R16, and back to hot terminal 25X. Zener diode Z2 is selected to create a preselected output voltage VDD for the power supply. Here, Z2 is a 12V Zener Diode to create a 12 VDC supply at terminal 30. When neutral is connected at terminal 27, current in the negative cycle goes through the following components to generate a power supply voltage: neutral terminal 27X, D1, OK1, R4, Q4, R5 in parallel with R7 and Q1, Z2, R16, and back to hot terminal 25X. Storage and filtering capacitors C1 and C2 act to stabilize the power supply voltage at terminal 30. Feedback circuit R10, R15 and C7 provide a 3 VDC signal, VOLTAGE_DET, signal 31 to microcontroller 20 for power-on reset to ensure reliable startup of the microcontroller. Signal 31 is a portion of signals 18.

When neutral is connected at the terminal 27X, current in the negative cycle goes through the infrared emitting diode which is embedded in the photo coupler OK1. The infrared signal turns on the photo transistor embedded in OK1 which then turns on Q2 and Q11. Q1 is turned on through Q2. The output of Q11 is neutral detection signal, pulse train 28 that is output to the microcontroller as signal NEUTRAL_DET at terminal 29. Signals 18 from power supply 16 include pulse train 28. When neutral conductor 27 is connected, there is no pulse train at terminal 29. The presence of pulse train 28 indicates earth connection whereas the lack of a pulse train indicates a neutral conductor connection. If both earth and neutral are connected, zener diode Z1 ensures that diode D2 is reversed biased, effectively taking earth connection 26 out of the circuit since no current can travel through that connection, so no pulse train is created and microcontroller 20 correctly interprets the presence of a neutral conductor at the input connection. Resistor R27 may or may not be present, it is used to stabilize the operation of optoisolator OK1.

When Q1 is on, current source 32 can supply 8 milliamperes or more, which is suitable for driving indicators 22 and relays directly at any time. Control device 12 would use this mode when it detects a neutral connection. Q2 is controlled in this configuration by hardware circuitry to improve reliability and responsiveness. Alternatively, the neutral detection circuit may be controlled by microcontroller firmware.

When Q1 is off, current source 32 can supply up to 0.5 milliamperes through careful selection of R5, which is the upper limit for leakage to ground devices per certain standards and building codes. Control device 12 would use this mode when it fails to detects a neutral connection at terminal 27 to limit the leakage to ground current, as well as avoid use of LEDs or other indicators 22, monitor how frequently the relay may be activated, and other power saving techniques as are known in the art (e.g., the microcontroller may put itself into a slower, less power consuming, operating frequency or clock).

Constant current source circuit 32 is controlled by bipolar junction transistor Q4 with negative feedback through resistor R5 and transistor Q6. As current through R5 increases and the voltage drop across R5 increases, Q6 starts to turn on and reduce the bias of Q4, thereby reducing the current delivered through R5. The value of R5 generally controls the amount of current available, which should be designed to limit the current to maximum acceptable for leakage to ground (i.e., 0.5 milliamperes). When Q1 is turned on through Q2, R5 is bypassed and the supplied current goes up significantly, primarily determined by the bias points of Q4 and R7. Constant current circuit 32 is controlled in this configuration by hardware circuitry to improve reliability and responsiveness. The constant current circuit may be controlled by microcontroller firmware which offers the opportunity to implement other checks before the constant current source is activated. Alternatively, the constant current circuit via hybrid hardware/logic methods as are known in the art, such as FPGA, ASIC, etc.

Using a zener diode to create a simple power supply is well known in the art. However, it is difficult to control power consumption of the controller because any unused current is shunted through the zener diode. This unused current can be significant if the controller is operating in a low power mode, such as when a neutral connection is unavailable. Typically, the zener diode is chosen to handle the current (power). In order to maintain low power consumption and use smaller, less expensive, lower power zener diodes, a no load power reduction circuit, circuit 33 is implemented. Resistor R16 and transistor Q8 work together to limit this no load current. If the current shunted through the zener diode is too high, R16 is designed to have a voltage developed across it sufficient to turn on Q8, which act to turn off Q4 and interrupt the power supply. Once the shunt current is reduced, Q8 turns off and Q4 turns back on through the voltage developed between R8 and C5, which also act to ensure that Q4 turns on during initial power up and also to stabilize the turn on and turn off times for Q4.

Resistors R5 and/or R7 may be switchable to other values or additional constant current circuits may be available and selectable, such as using a manually selectable DIP switch or an electronic switching arrangement, thereby allowing the minimum allowed current to be changed for particular installations. For example, some leakage to load applications may allow a current higher than 0.5 mA to be used, e.g., certain lamps maybe able to handle 2 mA or 5 mA and not affect the lamp's on/off operation. The user may set the device's current draw to match the leakage current capability of the load. The selectable switch settings may be provided to the microcontroller through feedback from the switch apparatus or directly if switching is under microcontroller control. Either way, the microcontroller may adapt its use of peripherals, indicators, etc. according to the amount of current available. This type of switchable current limit is also useful in other situations, such as demand response as is known in the art, and would allow potentially thousands of devices in a building or campus to reduce their current usage and contribute significantly to meeting the demand response requirements. Another current limit requirement may be to meet LEED or other so-called smart building or environmentally conscious building operation requirements. Methods for communicating the demand response or other current limit requirements to the device are well known in the art, e.g, networked devices or providing a signal wire to a stand alone device.

Although load control device 12 and power supply 16 are described as a leakage to ground devices, they may be adapted to work as a leakage to load power devices. Load control device 12 and power supply 16 employ a neutral detector, the circuit may be reconfigured to be a no-neutral detector (effectively, an earth ground detector), for example, by moving the optoisolator OK1 to between the earth terminal 26 and diode D2 thereby creating a pulse train when earth terminal is connected and the neutral terminal is not connected.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A load control device for controlling the application of electrical power to a load comprising:
a controller having a microprocessor;
one or more status indicators;
a negative half-wave power supply comprising:
a constant current source;
a neutral line detector;
wherein the power supply is operable to limit output current to a preset limit when electrical power is supplied using only an earth wire and a hot wire and the power supply is operative to deliver output current higher than the preset limit when electrical power is supplied using a neutral wire, an earth wire and a hot wire; and
wherein the neutral line detector generates one or more signals indicative of the electrical power being supplied by a neutral wire, an earth wire and a hot wire, the controller using the one or more signals to control the one or more status indicators.

2. The load control device of claim 1 wherein the power supply is operable as a leakage to ground device.

3. The load control device of claim 1 wherein the power supply is operable as a leakage to load device.

4. A load control device for controlling the application of electrical power to a load comprising:
a controller with a power supply,
wherein the power supply is operable to limit output current to a preset limit when electrical power is supplied using only an earth wire and a hot wire and the power supply is operative to deliver output current higher than the preset limit when electrical power is supplied using a neutral wire, an earth wire and a hot wire; and
wherein the power supply generates one or more signals indicative of the electrical power being supplied by a neutral wire, an earth wire and a hot wire, the controller using the one or more signals to control one or more status indicators.

5. The load control device of claim 4 wherein the power supply is operable as a leakage to ground device.

6. The load control device of claim 4 wherein the power supply is operable as a leakage to load device.
